(19) United States
(12) Patent Application Publication
(10) Pub. No.: US 2009/0050099 A1
(43) Pub. Date: Feb. 26, 2009

(54) POSITIONING PEG STRUCTURE OF A SINGLE-PULL REEL

(76) Inventor: WEN-HAN CHANG, Taipei City (TW)

Correspondence Address: LEONG C LEI, PMB # 1008, 1867 YGNACIO VALLEY ROAD, WALNUT CREEK, CA, 94598, US

(21) Appl. No.: 11/843,653

(22) Filed: Aug. 23, 2007

(51) Int. Cl. F02N 1/00

(52) U.S. Cl. 123/185.3

(57) ABSTRACT

A positioning peg structure of a single-pull reel is disclosed. The positioning structure provides the function of positioning of the cord after a second pull following the first pull of the cord. When the cord is pulled to rotate one round, a first positioning mechanism is formed. Thus, when the cord is pulled in one direction once, the cord is controlled to provide a plurality of multiple positioning such that the pulling distance can be precisely controlled.

### BACKGROUND OF THE INVENTION

(a) Technical Field of the Invention

The present invention relates to peg structure for positioning a cord of a reel.

(b) Description of the Prior Art

FIGS. 9 and 10 show a conventional reel A10 employing steel bead as the positioning structure. The reel A10 comprises a front cover A1, a spiral spring A2, a sliding seat A3, a transmission line A4, a positioning bead A5 and a rear cover A6. In this conventional reel, the spring A2 is used to restore the transmission line A4 and a steel bead A5 positioning structure is used. A multiple steel bead track A31 is provided at the bottom section of the sliding seat A3 to allow the steel bead A5 to roll along the track A31 and to engage. The designing of the track for the steel bead is difficult with respect to precision and the producing of a mold is laborious. Thus, the yield of the assembly will not be improved, and the cost of production will be increased.

Another drawback is that the friction of the track 31 or the gap formed is too large, this will cause the engagement being not possible. Thus, such conventional structure A10 is commonly not functioning or failure in engagement. Further, the transmission line cannot be gradually restored and positioned, and the accuracy of positioning at the track of the sliding seat is limited.

### SUMMARY OF THE INVENTION

The primary purpose of the present invention is to provide a positioning peg structure of a single-pull reel having a top cover, a cord-rotating disc, a cord, a spiral spring, a bottom cover and a peg positioning structure characterized in that the cord is wound respectively within an upper and a lower box of the cord-rotating disc, and both the windings in the upper and the lower box are in opposite direction to provide a loosening and a tightening winding of the cord, the upper box position is for the pulling cord and the lower box position is for the ready-to-rotate cord and the positioning of the cord is restricted by the peg positioning structure; wherein the peg positioning structure comprises a peg and a spring and is pivotally mounted at a positioning shaft located at the outer side of the interior of the bottom cover and the rear side of the positioning structure is pulled to close by the spring to constantly maintain the peg to point at a right direction and is urged to swing in accordance with the track for multi-operation function at the bottom section of the cord disc to proceed alternately with loosening and tightening operation, and the track includes a first push-to-close section, a second push-to-close section, a steering section, an engaging slot and a slanting leading face multi operation structure, wherein the first push-to-close section is a protruded section within the track; when the cord-rotating disc restores to the steering direction, the peg is pushed to large angle in clockwise and the peg is fully disengaged from engagement mechanism; the second push-to-close section is positioned at the rear direction of the first push-to-close section, which again pushes the peg to a larger angle clockwise to disengage from engagement mechanism; the steering section is the recess section of the track, when the cord-rotating disc is at clockwise rotation, the peg is rotated and restored to engage at a corner position, awaiting an engagement mechanism in the course of a reverse rotating; the engaging slot is mounted at the rear direction of the first push-to-close section to allow the peg, after a rotation, to be engaged so as to position the reel; and the slanting leading face, which directs peg into the engaging slot layer or the push-to-close layer during the clockwise and anti-clockwise rotation of the cord-rotating disc to allow the peg to accurately position at the engaging or disengaging mechanism.

Yet still another object of the present invention is to provide a positioning peg structure of a single-pull reel, wherein the positioning is trackless and disengagement of the cord will not be occurred.

The advantages of the present invention are

1. The apparatus provides a convenient mechanism in installation of cord or cables and the clean-up of cable after installation.

2. The required length of the cord can be easily and precisely positioned after a specific length is pulled.

3. Multiple positioning of cord is possible and high precision of length to be positioned can be achieved using the apparatus of the present invention.

4. The apparatus provides a fast and easy operation such that the restoration of the cord can be obtained gradually or at one operation.

5. The apparatus of the present invention overcomes the drawbacks due to wears and the gap formed by the steel bead and the sliding seat.

6. The installation of the apparatus of the present invention is simple, fast and convenient, and the yield is thus increased.

The foregoing object and summary provide only a brief introduction to the present invention. To fully appreciate these and other objects of the present invention as well as the invention itself all of which will become apparent to those skilled in the art, the following detailed description of the invention and the claims should be read in conjunction with the accompanying drawings. Throughout the specification and drawings identical reference numerals refer to identical or similar parts.

Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIG. 1 is a perspective view of the preferred embodiment of the present invention.

FIG. 2 is a perspective exploded view of the present invention.

FIGS. 3-8 show schematically the structure of the track of the cord-rotating disc and the positioning structure in accordance with present invention.

FIG. 9 is an exploded view of a conventional reel using the steel bead as positioning structure.

FIG. 10 is a schematic view showing the bottom section of the sliding seat of the conventional reel using the steel bead as positioning structure.

### DETAILED DESCRIPTION OF THE PREFERRED EMBODIMENTS

The following descriptions are of exemplary embodiments only, and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

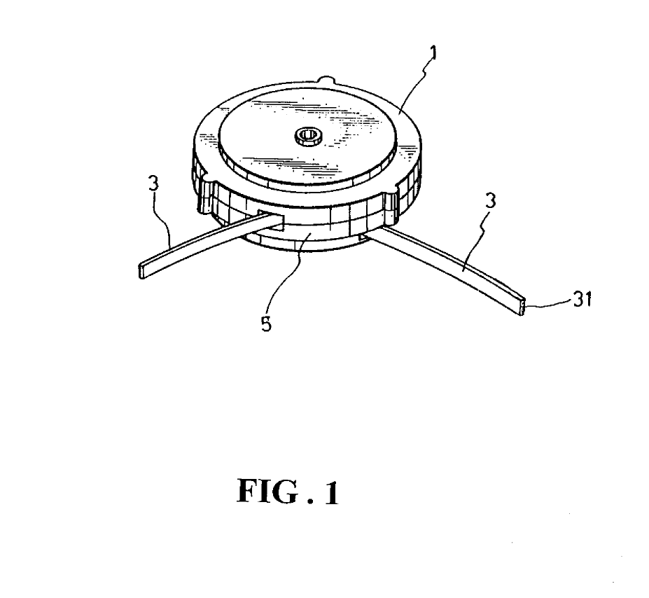

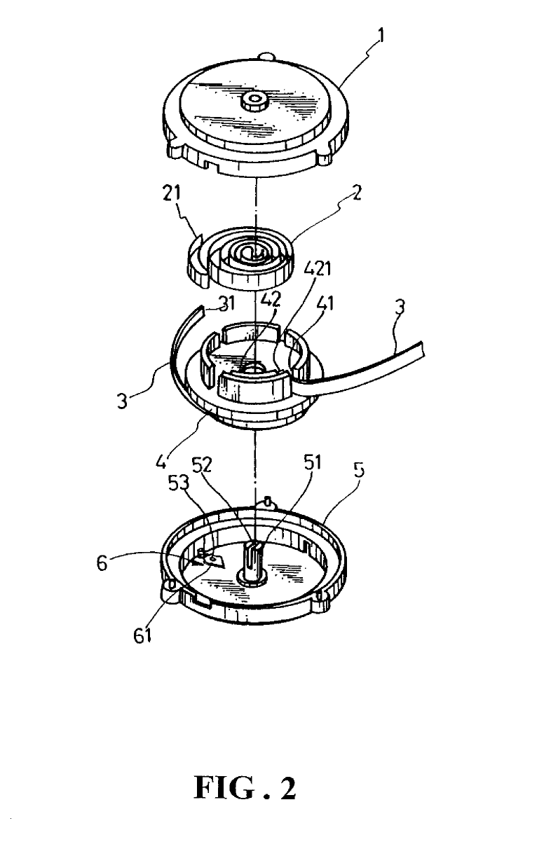

Referring to FIGS. 1 and 2, there is shown a positioning peg structure of a single-pull reel comprising a top cover 1, a spiral spring 2, a cord 3, a cord-rotating disc 4, a bottom cover 5 and a peg positioning structure 6. The center end of the spiral spring 2 is in engagement with the engaging slot 52 of the center shaft 51 within the interior of the bottom cover 5. Further, the outer end of the spiral spring 2 is secured to the engaging slot 41 of the cord-rotating disc 4 by means of an edge hook 21. When the cord-rotating disc 4 is rotated in clockwise or counter-clockwise, the spiral spring 2 at the interior is urged to be tightened or loosen. This provides the essential power source of rotating or restoration of the cord.

The edge wall of the cord rotating disc 4 is provided with an engaging plate 42 which causes the cord 3 to surround the upper box of the cord-rotating disc 4. When the cord 3 passes through the external edge of the lower box of the cord-rotating disc 4, the cord 3 is divided into an upper and lower box position. The upper box is for the pulling cord 3 and the lower box is for the ready-to-rotate cord 3. In accordance with the present invention, the characteristics are on the cord-rotating disc 4 and the peg positioning structure at the external side of the interior of the bottom cover 5. As shown in FIG. 2, the peg positioning structure 6 comprises a peg 61 and a pulling spring 62. The peg 61 is pivotally mounted to the positioning shaft 53 at the external side of the interior of the bottom cover 5, and the pulling spring 62 is used for fastening such that the peg 61 is constantly pointing to the correct direction.

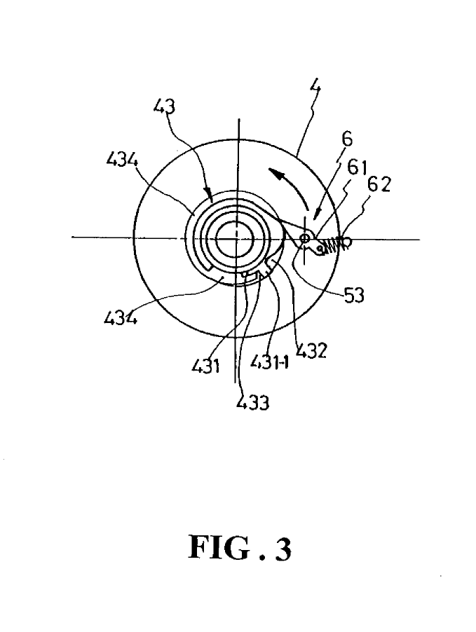

As shown in FIG. 3, the bottom section of the cord-rotating disc 4 is provided with a multi-operation urging track 43. The track 43 includes a first push to close section 431, a second push to close section 431-1, a steering section 432, an engaging slot 433 and a slanting leading face 434. As shown in FIG. 3, the peg 61 is at a large angle position and slanting upward and moving along the rotating direction will not generate an engaging operation. Thus, the peg 61 shown in the figure is being pulled.

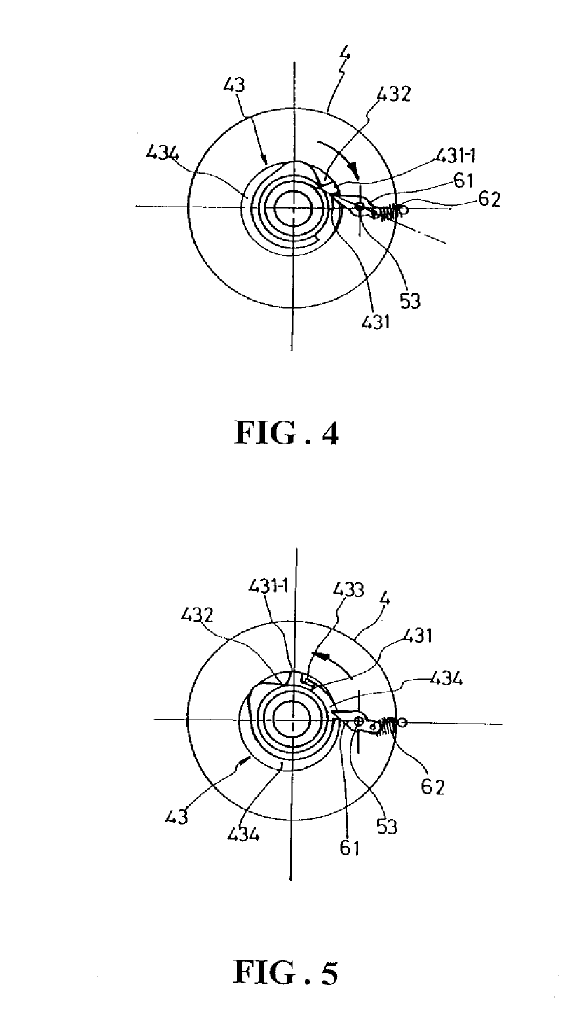

Referring to FIG. 4, when the reel is releasing, the spiral spring 2 restores to its power and the cord-rotating disc rotates in a counter clockwise direction. At this point of time, the peg 61 is directed to the engaging slot 433 such that a positioning is provided to the reel. The positioning is referring to the engagement of cord at a tangential angle, the positioning shaft 53 and the peg 61. The peg 61 is fully engaged and swinging will not occur, and therefore, the positioning of the reel is achieved.

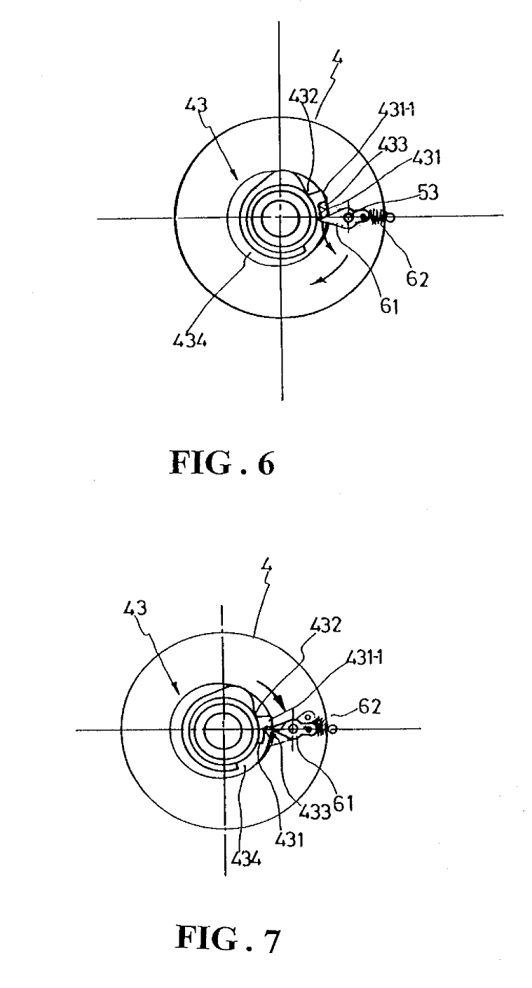

As shown in FIG. 6, when disengagement from the peg 61 is to be obtained, the cord at the reel is pulled again, and the cord-rotating disc 4 rotates in counter clockwise direction, as compared to the urging track 43 and the peg 61. The reverse rotating of the cord-rotating disc 4 causes the peg 61 to move along the slanting leading face 434 into the range of the push to close section 431 so as to quickly push the peg 61 to rotate, as shown in FIG. 6. After that, the second push to close section 431-1 causes the peg 61 to produce a large angle and moves into the range of the steering section 432, as shown in FIG. 7. At this point of time, the reel is at a loosening state. Thus, the cord 3 can one time pulls back the cord 3 being pulled by means of the spiral spring.

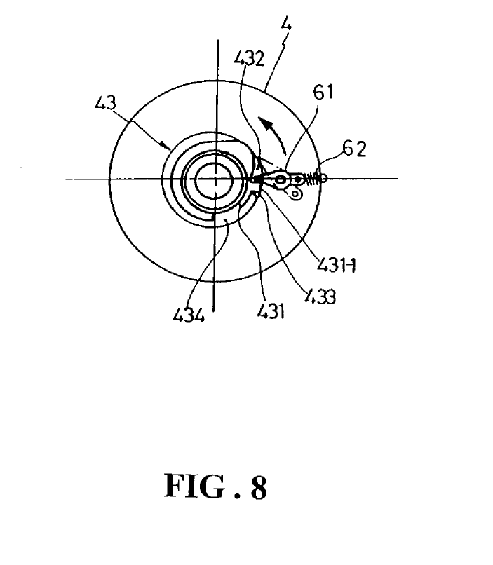

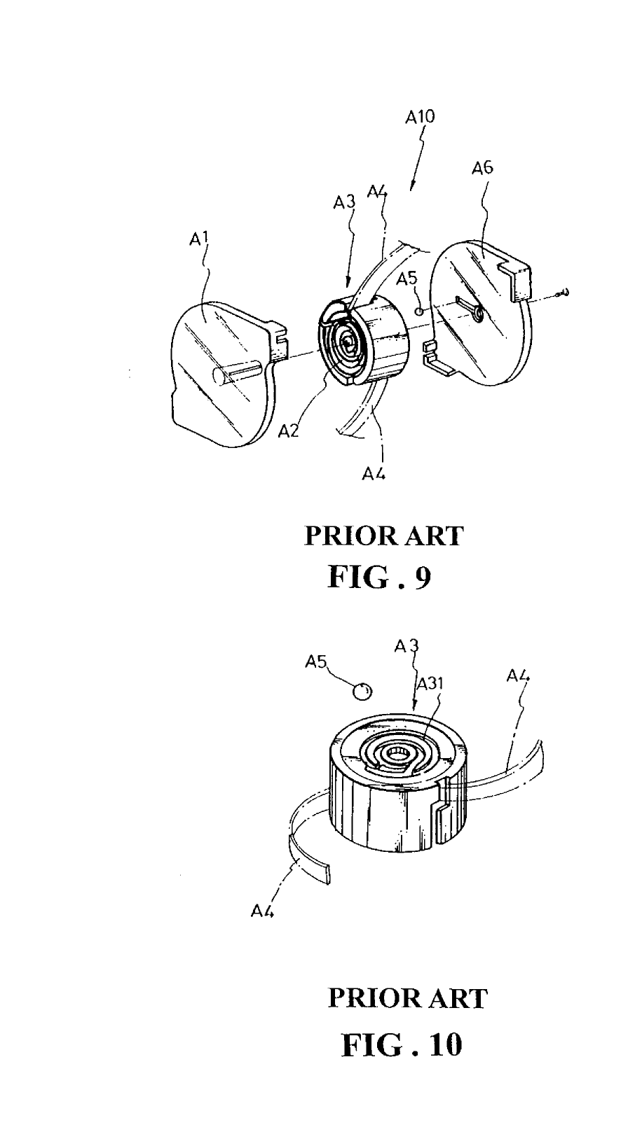

Referring to FIG. 8, the cord 3 is eventually reeling back or re-positioned. Before the cord 3 is positioned, the next pulling of the cord 3 will again rotate the cord-rotating disc 4 in a reverse direction. At this point of time, the peg 61 being restricted by the steering section 432 urging on the peg 61, the peg 61 is at a state shown in FIGS. 3 and 4, awaiting the reverse rotating to cause an engagement at the engaging slot 433.

The ready-to-rotate cord 3 at the bottom box of the cord-rotating disc 4 is at a tightening state under a single directional pulling of the cord 3, so as to respond to the required length of the rotation. On the other hand, when the cord 3 is restored to its original position, the ready-to-rotate cord at the bottom box is at a loosening position, thus, both of the operation are corresponding to each other. Thus, the reel under a single cord could achieve the function a single-pull cord, and will not affect the terminal or signal transmission point required by the ready-to-rotate cord end 31.

It will be understood that each of the elements described above, or two or more together may also find a useful application in other types of methods differing from the type described above.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the spirit of the present invention.

1. (canceled)

2. A single-pull reel comprising:
a top cover;
a cord-rotating disc provided with an engaging slot, an edge wall of said cord-rotating disc is provided with an engaging plate, said cord-rotating disc being provided with an upper box and a lower box, said cord-rotating disc being provided with a multi-operation urging track which includes a first push-to-close section, a second push-to-close section, a steering section, a first engaging slot and a slanting leading face;
a cord first surrounding said upper box of said cord-rotating disc and then passing through an external edge of said lower box of said cord-rotating disc;
a spiral spring having an outer end provided with an edge hook which is secured to said first engaging slot of said cord-rotating disc;
a bottom cover provided with a positioning shaft and a center shaft, said center shaft having a top end formed with a second engaging slot; and
a peg positioning structure comprising a peg and a pulling spring, said peg being pivotally mounted to said positioning shaft, said pulling spring urging said peg to point to a determined direction, said peg slanting upward with respect to a center of said track such that rotation of said cord-rotating disc will not generate an engaging operation;
whereby when said reel is released, said spiral spring will restore power and said cord-rotating disc will rotate in a reverse direction and then said peg will move along said track to engage with said first engaging slot of said cord-rotating disc thereby providing a positioning to said reel; when desired to disengage said peg from said first engaging slot of said cord-rotating disc, it is only necessary to pull said cord to rotate said cord-rotating disc thereby causing said peg to move along said slanting leading face of said cord-rotating disc into a range of said first push-to-close section so as to quickly push said peg to rotate, and then said second push-to-close section will cause said peg to move into a range of said steering section thereby causing said reel at a loosening state.
